(19) United States
(12) Patent Application Publication
(10) Pub. No.: US 2004/0076383 A1
(43) Pub. Date: Apr. 22, 2004

(54) Self-aligned metal base/window cap and methods of aligning a laser diode chip to a window cap for high speed semiconductor laser package

(76) Inventors: Huei Peng, Fremont, CA (US); Bingwen Liang, Sunnyvale, CA (US)

Correspondence Address: Huei Peng, 35964 Vivian PL, Fremont, CA, 94536, US

(21) Appl. No.: 10/273,315

(22) Filed: Oct. 17, 2002

(51) Int. Cl. G02B 6/36

(52) U.S. Cl. 385/92

(57) ABSTRACT

Metal bases and window caps are used for semiconductor laser diode transistor-outline (TO) type packages and the like. New types of metal bases and window caps are disclosed. Tapered metal bases of the present invention works with tapered window caps of the present invention to function as a self-alignment mechanism of them, which is especially important for the ball lens window caps. The self-aligned tapered metal bases and tapered window caps provide a more productive (high yield), cost effective, and accurate means to manufacture semiconductor laser diode packages, which is a key factor for high-speed semiconductor laser diode application. The top surface of a metal base of the present invention has at least two fiducial marks designed to serve as the reference for the process automatic equipment to search and define the center of the metal base. These references will improve the accuracy of process equipment placing the laser diode chip and/or dispensing adhesive. To simplify the wire bonding process and make it robust, a two-bonding-surface post and a tilted-top post are disclosed in the present invention to eliminate the rotation process between two sequential bonding steps.

### BACKGROUND OF THE INVENTION

(1) Field of the Invention

The present invention relates to new types of metal bases and window caps for high-speed semiconductor laser diode transistor-outline (TO) type packages and the like and methods of aligning a laser diode chip to a metal base, and of self-aligning a window cap to the metal base so that the laser diode chip is automatically and indirectly aligned to the window cap with accuracy. This is one of crucial factors for manufacturing high-speed semiconductor laser diode packages and coupling optical fibers to laser diode packages. The present invention also relates to a metal base comprising a new feature, a post having two bonding surfaces, ensuring a reliable, inexpensive, and productive wire bonding process.

(2) Prior Art

The semiconductor laser diode package is well known in the prior art. Optical fiber is commonly used to guide laser light over a long distance. In order to couple a laser beam into an optical fiber the laser diode chip must be properly aligned with an optical element (a lens or lenses) so that as much laser light as possible is coupled into the optical fiber.

In the processing of semiconductor laser diode package, a laser diode chip is placed onto a metal base to a certain degree of accuracy, and a window cap is welded to the metal base. By doing this the laser diode chip is aligned to the window cap. For fiber optics applications a piece of optical fiber then is aligned to the laser diode package. If the alignments are not accurate enough, most of the laser light will get lost. The whole package will fail for high-speed applications.

There are varieties of prior art discussing devices and methods of aligning laser diode package to optical fiber. However those devices and methods are complex and expensive. Those prior art include U.S. Pat. No. 5,751,877 by Ishizaka et al., U.S. Pat. No. 6,244,754 B1, by Takagi et al., U.S. Pat. No. 5,870,517 by Wyland, U.S. Pat. No. 5,485,479 by Kitamura et al., U.S. Pat. No. 5,953,355, by Kiely et al., U.S. Pat. No. 5,939,773, by Jiang et al., U.S. Pat. No. 6,034,424, by Fujimura et al.

To align an optical fiber to laser diode package, one of methods is known as active alignment. FIG. 56 is a copy of FIG. 5 of U.S. Pat. No. 6,034,424 and shows pigtail 562 connected to a laser diode package that comprises window cap 564 with ball lens 563, laser diode chip 565 placed on top surface 566 of metal base 567. During active alignment process, the laser diode chip 565 is powered, and testing equipment and automatic alignment equipment are used to test, place, and weld pigtail 562 to the laser diode package. If ball lens window cap 564 did not align to metal base 567 accurately, and/or the laser chip 565 did not align to the metal base 567 accurately, the laser diode chip 565 would not be aligned to the ball lens 563 accurately. As a result this package would be rejected in the following testing step. In this case the throughput and yield of the active alignment would be very low. There is no discussion about alignment between laser diode chip, metal base, and ball lens cap in this prior art.

There is lack of prior art that discusses aligning a laser diode chip to a window cap.

(A). For Vertical-Cavity Surface-Emitting Laser (VCSEL) Type of Packages

Prior to aligning a piece of optical fiber to a laser diode package, it is desired to align the laser diode chip to the window cap, especially a ball-lens window cap. Otherwise a significant amount of laser light will get lost before it comes out the ball-lens window. Also when the alignment of a laser diode chip to a window cap, either a flat window cap or a ball-lens window cap, is not accurate enough, it would be impossible to align an optical fiber to that semiconductor laser diode package optically, even the active alignment for connecting an optical fiber to a semiconductor laser diode package is used.

There are two steps in the alignment procedure: (1) align the laser diode chip to a metal base using pick/place process, and (2) align a window cap to the metal base during welding process.

In the first alignment step, the pattern recognition (PR) system of automatic equipment is employed to find the center of the metal base by using either the outer edge of the top surface of the metal base or the edges of post-housing holes as fiducial marks. And then a laser diode chip is picked and placed to the center of the metal base. However the image of the chamfered outer edge of the top surface of the metal base is blur for the PR system of the automatic equipment. The blur imaging introduces a significant error in finding the center of the metal base. When using the post-housing holes as fiducial marks, the sub-mount and/or the monitoring photodiode (PD) chip used may block a fraction of the holes. Therefore the PR system cannot find those fiducials unless a lower recognition threshold is used. The lower recognition threshold itself will introduce an uncertain error.

In the second alignment step, a typical metal base 11 of prior art as shown in FIG. 1a and FIG. 1b comprises a mesa 18, vertical side surface 13 of mesa 18, and bottom flange 16. A high-speed metal base 61 of prior art as shown in FIG. 6a and FIG. 6b comprises a mesa 65, vertical side surface 68 of mesa 65, and bottom flange 63. High-speed metal base 61 is designed for 20 GHZ and higher.

A typical window cap 301 of prior art as shown in FIG. 30 comprises a vertical inside surface 303, foot 304, and projection 305. During welding process, foot 304 sits on bottom flange 16 of metal base 11 or bottom flange 63 of metal base 61, mesa 18 or mesa 65 confine the position of window cap 301 to certain degree, and projection 305 will be melted to weld foot 304 of window cap 301 to the bottom flange of metal bases, either metal base 11 or high-speed metal base 61.

The combination of the mechanical tolerances of the window cap's inner diameter of vertical inside surface 303 and the outer diameter of vertical side surface 13 of mesa 18 or vertical side surface 68 of mesa 65 may introduces alignment error in the alignment of the window cap to the metal base. This error is too big to accept for high-speed applications and this is one of reasons why there is no low-cost high-speed laser diode package on current market (there is no 2.5 GHZ ball lens laser diode package on current market).

In practice there is a strong need for new types of metal bases and window caps designed with features that can provide a self-alignment mechanism for semiconductor laser TO-can type of package and the like with lower cost and simple fabrication.

(B). For Edge-Emitting Laser Type of Packages

There are two main issues needed to be resolved for edge emitting laser package: (1) alignment between a metal base and a window cap; (2) wire bonding two surfaces they are not on the same plane.

FIG. 10 is a typical drawing of prior art of the metal base for an edge-emitting laser diode (LD) package. Similar to VCSEL package, there is an alignment issue for edge emitting laser diode package. Unlike the metal bases for VCSEL package, there is no mesa sitting on the top surface of bottom flange 104 for edge emitting laser diode package. A window cap is directly welded onto the top surface of bottom flange 104. Therefore there is no physical surface to confine the position of a window cap and makes the alignment more difficult. Active alignment method is employed for only aligning x-y position at TO can package level.

Therefore there is also a strong need for new types of metal bases and window caps designed with features that can provide a self-alignment mechanism for edge emitting laser TO-can type package and the like with lower cost and simple fabrication.

At the center portion of the bottom flange, there is an area that is at an angle to the top surface of the bottom flange, hereafter called tilted area, as shown in FIG. 22. Typically the tilted area is for mounting PD monitoring chip.

There is another structure for mounting PD monitoring chip that is to use a post with bent and flattened top portion, hereafter called L post, as shown in FIG. 10 prior art.

There are three kinds of commonly used metal basest, type A, B, and C. Type A and B comprise a cylinder shape post with the top surface approximately parallels to the top surface of the bottom flange, hereafter called post, and a post with the top portion flattened, hereafter called flattened-top post. Type C, as shown in FIG. 16 and FIG. 22, comprises two of flattened-top posts. The flattened top surface of flattened-top posts approximately parallel to the vertical side surface of the pedestal. Laser chip is mounted on the vertical side surface of the pedestal.

For type C metal base, laser chip is bonded to the two flattened-top posts without needing to rotate the metal base. The PD chip need to be bonded to the flattened top surface of one of flattened-top posts. Therefore the metal base needs to be rotating during bonding the same wire.

For Type A and B metal bases, the top surface of monitoring PD chip is bonded to either the top surface of the post, or the flattened top surface of the flattened-top post. The laser chip is wire bonded to both the flattened surface of the flattened-top post and the top surface of the post. Rotating the metal base is needed during the bonding process.

For manual wire bonding, rotating the metal base is time consuming. For an automatic wire bonder, rotating the metal base is a very expensive function.

Therefore a new type of metal bases is needed to eliminate the need of rotation.

### BRIEF SUMMARY OF THE INVENTION

In the present invention, (1) metal bases and window caps with self-alignment structure for self-aligning a window cap to a metal base are disclosed; (2) metal bases with new features for the pattern recognition (PR) system of automatic equipment to find the center of the metal base are disclosed; (3) Metal bases with a post having two bonding surfaces for reliably wire bonding without rotating the metal base between two wire bonding steps are disclosed.

There are at least two fiducial marks on the top surface of mesa of metal bases of this invention. Those fiducial marks are for the PR system of an automatic equipment to find the center of a metal base. The edge of the top surface of the mesa of the metal base is sharp and flat, i.e., the edge is non-chamfered. This feature is also for the PR system of automatic equipment to accurately find the center of the metal base. Therefore automatic equipment can place laser diode chips or dispense adhesive accurately.

Both the inside surface of a window cap and the side surface of the mesa of a metal base of this invention are tapered to the approximately same angle so that the tapered window cap will be self-aligned to the tapered metal base when the window cap is placed on the metal base.

A post of a metal base of the present invention comprises two bonding surfaces, one surface is approximately parallel to the laser chip that is mounted to the vertical surface of the pedestal, another surface is approximately parallel to the monitoring PD chip which is mounted on either tilted area or L post or the like.

The top surface of a post of the present invention is tilted so that the tilted top surface of the post is approximately parallel to the top surface of the L post, which is commonly used to hold the monitoring PD chip. With these features, a regular wire bonder can reliably bond the wire to both surfaces without rotating the metal base after first bond.

The primary object of the present invention is to provide new types of metal bases and window caps comprising features such that the window cap will accurately self-align to the metal base, and therefore high-speed laser diode package with or without connecting to optical fiber will be manufactured with high yield and high throughput.

The second object of this invention is to provide new types of metal base comprising features such that a laser diode chip can be accurately placed onto it.

The third object of the present invention is to provide new types of metal base with features such that the wire bonding process is reliable and inexpensive.

Further objects and advantages of the present invention will become apparent from a consideration of the ensuing description and drawings.

### BRIEF DESCRIPTION OF THE SEVERAL VIEWS OF DRAWINGS

The novel features believed characteristic of the present invention are set forth in the claims. The invention itself, as well as other features and advantages thereof will be best understood by referring to detailed descriptions that follow, when read in conjunction with the accompanying drawings, wherein:

FIG. 1a is a partially sectional view of metal base 11 of a typical prior art.

FIG. 2b is a top view of metal base 11.

FIG. 2 is a partially sectional view of tapered metal base 21 showing a preferred embodiment of the present invention.

FIG. 3 is a partially sectional view of tapered metal base 31 showing a preferred embodiment of the present invention.

FIG. 4 is a top view of metal base 41 with fiducial marks showing a preferred embodiment of the present invention.

FIG. 5a is a top view of metal base 51 with fiducial marks showing a preferred embodiment of the present invention.

FIG. 5b is a top view of metal base 55 with fiducial marks showing a preferred embodiment of the present invention.

FIG. 6a is a sectional view of high-speed metal base 61 of prior art.

FIG. 6b is a top view of high-speed metal base 61 of prior art.

FIG. 7 is a sectional view of tapered high-speed metal base 71 showing a preferred embodiment of the present invention.

FIG. 8 is a sectional view of tapered high-speed metal base 81 showing a preferred embodiment of the present invention.

FIG. 9a is a top view of high-speed metal base 91 with fiducial marks showing preferred embodiment of the present invention.

FIG. 9b is a top view of high-speed metal base 93 with fiducial marks showing preferred embodiment of the present invention.

FIG. 9c is a top view of high-speed metal base 94 with fiducial marks showing preferred embodiment of the present invention.

FIG. 10a is a sectional view of metal base 101 of prior art.

FIG. 10b is the top view of metal base 101.

FIG. 10c is the sectional view of the metal base 101.

FIG. 11 is a sectional view of tapered metal base 111 showing a preferred embodiment of the present invention.

FIG. 12a is a sectional view of metal base 121 showing a preferred embodiment of the present invention.

FIG. 12b is the top view of metal base 121.

FIG. 12c is the sectional view of the metal base 121.

FIG. 13a is a sectional view of metal base 131 showing a preferred embodiment of the present invention.

FIG. 13b is the top view of metal base 131.

FIG. 13c is the sectional view of the metal base 131.

FIG. 14a is a sectional view of metal base 141 showing a preferred embodiment of the present invention.

FIG. 14b is the top view of metal base 141.

FIG. 14c is the sectional view of the metal base 141.

FIG. 15 is a sectional view of tapered metal base 151 showing a preferred embodiment of the present invention.

FIG. 16a is a sectional view of metal base 161 of prior art.

FIG. 16b is the top view of metal base 161.

FIG. 16c is the sectional view of the metal base 161.

FIG. 17 is a sectional view of tapered metal base 171 showing a preferred embodiment of the present invention.

FIG. 18a is a sectional view of metal base 181 showing a preferred embodiment of the present invention.

FIG. 18b is the top view of metal base 181.

FIG. 18c is the sectional view of the metal base 181.

FIG. 19a is a sectional view of metal base 191 showing a preferred embodiment of the present invention.

FIG. 19b is the top view of metal base 191.

FIG. 19c is the sectional view of the metal base 191.

FIG. 20 is a sectional view of tapered metal base 201 showing a preferred embodiment of the present invention.

FIG. 21 is a sectional view of tapered metal base 211 showing a preferred embodiment of the present invention.

FIG. 22a is a sectional view of metal base 221 of prior art.

FIG. 22b is the top view of metal base 221.

FIG. 22c is the sectional view of the metal base 221.

FIG. 23 is a sectional view of tapered metal base 231 showing a preferred embodiment of the present invention.

FIG. 24a is a sectional view of metal base 241 showing a preferred embodiment of the present invention.

FIG. 24b is the top view of metal base 241.

FIG. 24c is the sectional view of the metal base 241.

FIG. 25 is a sectional view of tapered metal base 251 showing a preferred embodiment of the present invention.

FIG. 26 is a sectional view of metal base 261 showing a preferred embodiment of the present invention.

FIG. 27a is a sectional view of metal base 271 showing a preferred embodiment of the present invention.

FIG. 27b is a top view of metal base 271.

FIG. 27c is a sectional view of metal base 271.

FIG. 28 is a sectional view of tapered metal base 281 showing a preferred embodiment of the present invention.

FIG. 29 is a sectional view of tapered metal base 291 showing a preferred embodiment of the present invention.

FIG. 30a is a sectional view of ball lens window cap 301 of prior art.

FIG. 30b is a partially sectional view of ball lens window cap 309, which has an irregular ball lens, of prior art.

FIG. 31 is a sectional view of tapered ball lens window cap 311 showing a preferred embodiment of the present invention.

FIG. 32 is a sectional view of tapered ball lens window cap 321 showing a modification of tapered ball lens window cap 311.

FIG. 33 is a sectional view of tapered ball lens window cap 331 showing a modification of tapered ball lens window cap 311.

FIG. 34 is a sectional view of partially tapered ball lens window cap 341 showing a preferred embodiment of the present invention.

FIG. 35 is a sectional view of partially tapered ball lens window cap 351 showing a modification of partially tapered ball lens window cap 341.

FIG. 36 is a sectional view of partially tapered ball lens window cap 361 showing a modification of partially tapered ball lens window cap 341.

FIG. 37 is a sectional view of tapered ball lens window cap 371 with partially tapered inside surface showing a preferred embodiment of the present invention.

FIG. 38 is a sectional view of tapered ball lens window cap 381 with partially tapered inside surface showing a modification of tapered ball lens window cap 371.

FIG. 39 is a sectional view of tapered ball lens window cap 391 with partially tapered inside surface showing a modification of tapered ball lens window cap 371.

FIG. 40 is a partially sectional view of flat window cap 401 of prior art.

FIG. 41 is a sectional view of tapered flat window cap 411 showing a preferred embodiment of the present invention.

FIG. 42 is a sectional view of tapered flat window cap 421 showing a modification of tapered flat window cap 411.

FIG. 43 is a sectional view of tapered flat window cap 431 showing a modification of partially tapered flat window cap 411.

FIG. 44 is a sectional view of partially tapered flat window cap 441 showing a preferred embodiment of the present invention.

FIG. 45 is a sectional view of partially tapered flat window cap 451 showing a modification of partially tapered flat window cap 441.

FIG. 46 is a sectional view of partially tapered flat window cap 461 showing a modification of tapered flat window cap 441.

FIG. 47 is a sectional view of tapered flat window cap 471 with partially tapered inside surface showing a preferred embodiment of the present invention.

FIG. 48 is a sectional view of tapered flat window cap 481 with partially tapered inside surface showing a modification of tapered flat window cap 471.

FIG. 49 is a sectional view of tapered flat window cap 491 with partially tapered inside surface showing a modification of tapered flat window cap 471.

FIG. 50 is a partially sectional view of an assembly of tapered metal base 31 and tapered ball lens window cap 311 as a preferred embodiment of the present invention.

FIG. 51 is a sectional view of an assembly of tapered metal base 201 and tapered ball lens window cap 311 as a preferred embodiment of the present invention.

FIG. 52 is a partially sectional view of an assembly of tapered metal base 31 and tapered flat window cap 411 as a preferred embodiment of the present invention.

FIG. 53 is a sectional view of an assembly of tapered metal base 201 and tapered flat window cap 411 as a preferred embodiment of the present invention.

FIG. 54 is a partially sectional view of an assembly of tapered metal base 31 and tapered ball lens window cap 381 as a preferred embodiment of the present invention.

FIG. 55 is a sectional view of an assembly of tapered metal base 211 and tapered ball lens cap 381 as a preferred embodiment of the present invention.

FIG. 56 is a partially sectional view of an assembly of a prior art of a semiconductor laser diode package with a pigtail.

### DETAILED DESCRIPTION OF THE INVENTION

While embodiments of this invention will be described below, those skilled in the art will recognize that other structures and methods are capable of implementing the principles of this invention. Thus the following description is illustrative only and not limiting.

Reference is specifically made to the drawings wherein like numbers are used to designate like members throughout.

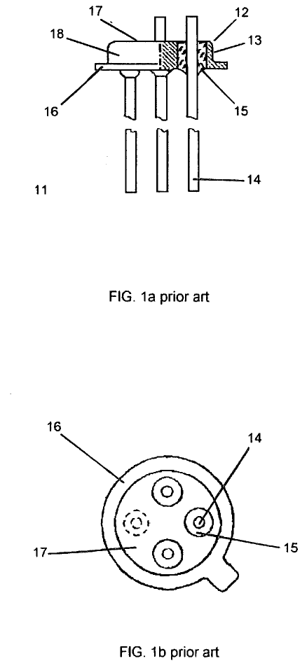

FIG. 1a is a partially sectional view of metal base 11 of prior art. Metal base 11 comprises post 14, post housing 15, bottom flange 16, mesa 18 sitting on the top of bottom flange 16, vertical side surface 13 of mesa 18, top surface 17 of mesa 18, and chamfered edge 12 intersecting top surface 17 and vertical side surface 13. Post housing 15 are holes through metal base 11. Through post housing 15 a plurality of posts is fixed by insulating material.

FIG. 1b is a top view of metal base 11. There is no fiducial mark on top surface 17.

It is a common and easy way to find the center of a metal base first, and use the center as a reference point to determine where to place a laser chip and/or to dispense epoxy. The positions of post 14 vary in post-housing 15 due to the manufacturing process of metal bases. Therefore post 14 cannot be used as fiducial marks for finding the center of metal bases.

Both chamfered edge 12 and post housing 15 are commonly used by the pattern recognition (PR) system of automatic equipment as fiducial marks to find the center of metal bases. However, since both post housing 15 will be partially covered by a sub-mount or a monitoring photodiode (PD) chip and chamfered edge 12 will be blur for the PR system, the founded center of metal bases will not be accurate. And the placement of semiconductor laser-diode chip or the dispensing of epoxy will not be accurate.

This kind of metal base is commonly used for vertical-cavity surface emitting laser (VCSEL) diode package and the like.

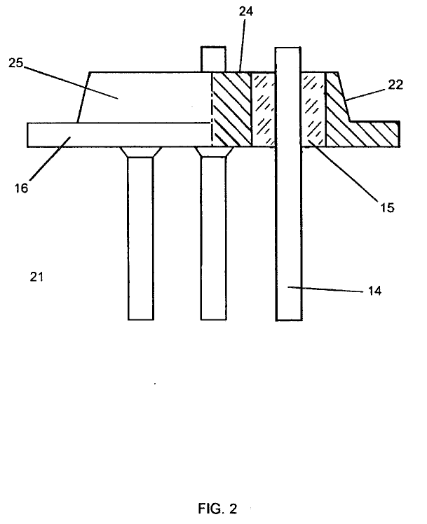

FIG. 2 is a partially sectional view of tapered metal base 21, comprising a mesa 25, top surface 24 of mesa 25, tapered side surface 22 of mesa 25, bottom flange 16, post housing 15, post 14, and non-chamfered edge 23 intersecting top surface 24 and tapered side surface 22.

Metal base 21 replaces mesa 18 having vertical side surface 13 in FIG. 1a with mesa 25 having tapered side surface 22. Tapered side surface 22 works with a tapered window cap to provide a self-alignment means to align the tapered window cap to the tapered metal base. Therefore, the semiconductor laser chip that is aligned with the tapered metal base will accurately align to the tapered window cap automatically.

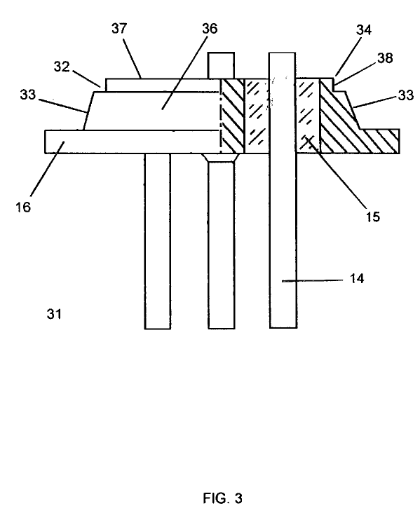

FIG. 3 is a partially sectional view of metal base 31, comprising a mesa 36, top surface 37 of mesa 36, tapered side surface 33 of mesa 36, bottom flange 16, step 32 surrounding top surface 37 and between top surface 37 and tapered side surface 33, vertical side surface 38 of step 32, post housing 15, post 14, and non-chamfered edge 34 intersecting top surface 37 and vertical side surface 38.

Metal base 31 adds a new feature, step 32, to metal base 21, which is for the PR system of automatic equipment to be able to find reference point accurately.

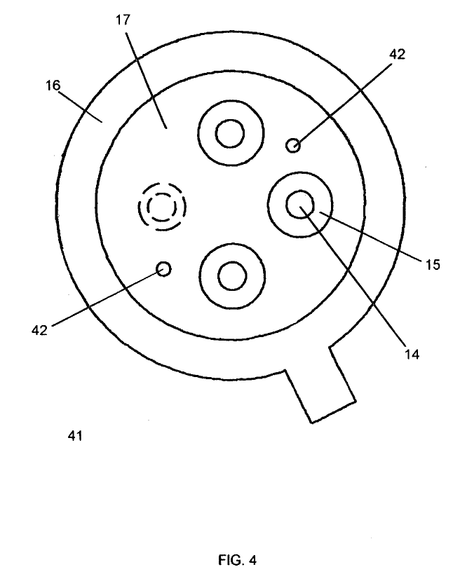

FIG. 4 is a top view of metal base 41, comprising bottom flange 16, top surface 17, and two of circular fiducial mark 42 on top surface 17.

Metal base 41 provides two fiducial marks on a diagonal line to metal base 11 of prior art, those fiducial marks are for the PR system of automatic equipment to be able to find reference point accurately.

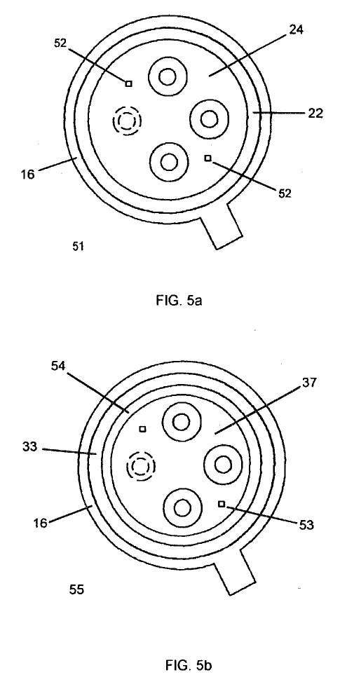

FIG. 5a is a top view of metal base 51. Metal base 51 has the same sectional view as metal base 21 and comprises bottom flange 16, top surface 24, tapered side surface 22, and two of square fiducial mark 52 on top surface 17.

FIG. 5b is a top view of metal base 55. Metal base 55 has the same sectional view as metal base 31 and comprises bottom flange 16, top surface 37, tapered side surface 33, the horizantal surface 54 of step 32, and two of square fiducial mark 53 on top surface 37.

Although there are two of square fiducial marks 52 on top surface 24 in FIG. 5a, two of square fiducial marks 53 on top surface 37 in FIG. 5b, and two of circular fiducial marks 42 on top surface 17 in FIG. 4, the shape of fiducial marks is not limited to circular or square. Other shapes may be used as fiducial marks too. The number of fiducial marks needs to be at least two and they are on diagonal positions for orientation. Fiducial mark 42, 52 and 53 allow the PR system of automatic equipment to find the location for the placement of a laser chip or dispensing of epoxy on the metal base accurately.

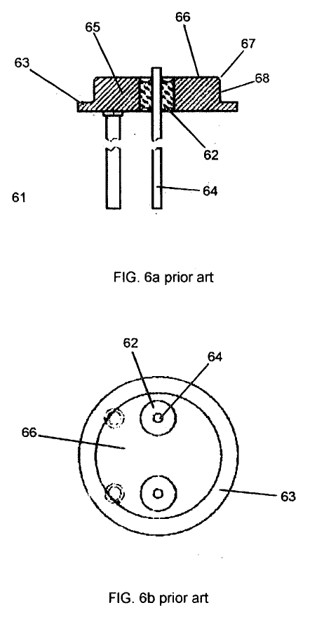

FIG. 6a is a sectional view of high-speed metal base 61 of prior art, comprising post 64, post housing 62, mesa 65, bottom flange 63, and top surface 66 of mesa 65. Mesa 65 sits on the top of bottom flange 63 and has vertical side surface 68. Chamfered edge 67 intersects top surface 66 and vertical side surface 68. Since metal base 61 and the like are designed for high-speed application, the alignment is very critical.

FIG. 6b is a top view of metal base 61. There is no fiducial mark on top surface 66.

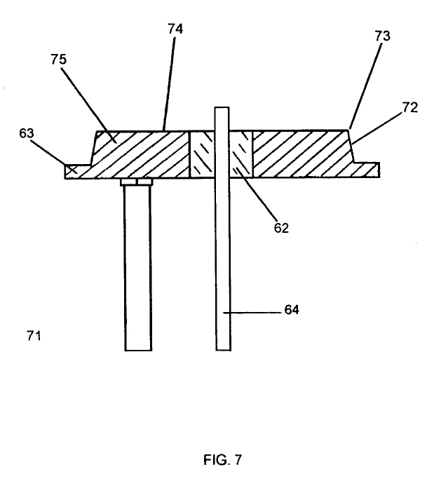

FIG. 7 is a sectional view of tapered high-speed metal base 71, comprising mesa 75, top surface 74 of mesa 75, tapered side surface 72 of mesa 75, bottom flange 63, post housing 62, post 64, and non-chamfered edge 73 intersecting top surface 74 and tapered side surface 72. Tapered high-speed metal base 71 has a new feature, tapered side surface, that provides self-alignment means for accurately aligning tapered high-speed metal base to tapered window cap.

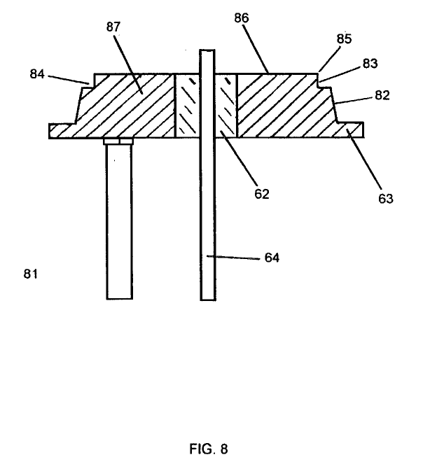

FIG. 8 is a sectional view of tapered high-speed tapered metal base 81, comprising a mesa 87, top surface 86 of mesa 87, tapered side surface 82 of mesa 87, bottom flange 63, tapered side surface 82 is at an angle to the top surface of bottom flange 63, step 84 surrounding top surface 86 and between top surface 86 and tapered side surface 82, vertical side surface 83 of step 84, post housing 62, post 64, edge 85 intersecting top surface 86 and vertical side surface 83. High-speed metal base 81 shows a new feature, step 84, added to tapered high-speed metal base 71, that allow PR system of automatic equipment to find the center of metal base accurately.

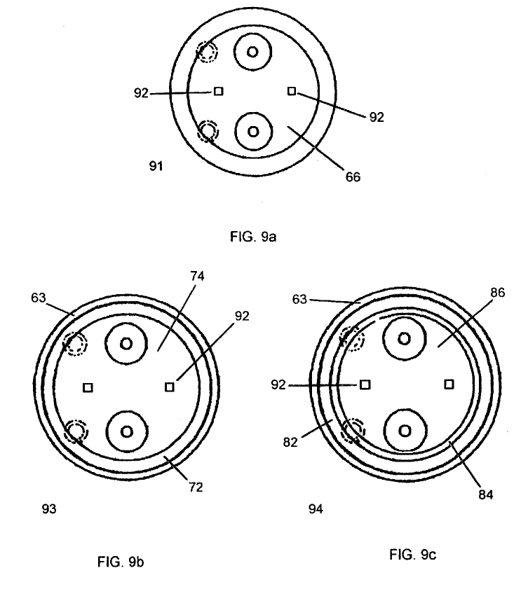

FIG. 9a is a top view of high-speed metal base 91. Metal base 91 has the same sectional view as metal base 61 and comprises two of square fiducial mark 92 on top surface 66. Two of fiducial mark 92 are on a diagonal line and are not limited to square shape. Metal base 91 shows a new feature, fiducial marks, added to high-speed metal base 61 of prior art.

FIG. 9b is a top view of tapered high-speed metal base 93. Metal base 93 has the same sectional view as metal base 71 and comprises two of square fiducial mark 92 on top surface 74, bottom flange 63, and tapered side surface 72. Two of fiducial mark 92 are on a diagonal line and are not limited to square shape. Metal base 93 shows a new feature, fiducial marks, added to tapered high-speed metal base 71.

FIG. 9c is a top view of tapered high-speed metal base 94. Metal base 94 has the same sectional view as metal base 81 and comprises two of square fiducial mark 92 on top surface 86, bottom flange 63, tapered side surface 82, and the horizontal surface of step 84. Two of fiducial mark 92 are on a diagonal line and are not limited to square shape. Metal base 94 shows a new feature, fiducial marks, added to tapered high-speed metal base 81.

The combination of step 84, vertical side surface 83, fiducial mark 92, and edge 85 allows the PR system of automatic equipment to accurately find the center of metal bases. Therefore the placement of semiconductor laser diode chip or dispensing of epoxy onto metal bases will be accurate. Tapered side surface 82 allows a tapered window cap to align with the tapered high-speed metal bases.

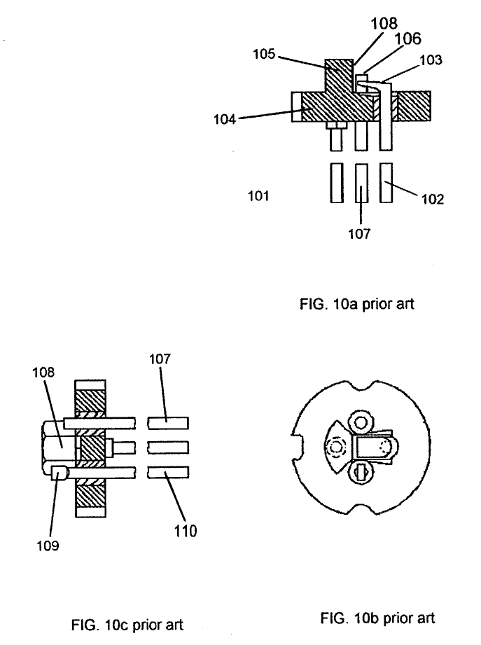

FIG. 10a is a sectional view of metal base 101 of prior art, comprising post 107, top surface 106 of post 107, bottom flange 104, L post 102, top surface 103 of L post 102, pedestal 105 sitting on bottom flange 104, and vertical side surface 108 of pedestal 105. Top surface 103 is at an angle to the top surface of bottom flange 104. Pedestal 105 is for mounting edge emitting laser diode chip.

FIG. 10b is a top view of metal base 101.

FIG. 10c is a sectional view of metal base 101, comprising flattened-top post 110, flattened-top surface 109 of flattened-top post 110. Flattened-top surface 109 approximately parallels to vertical side surface 108.

There are three different posts in FIG. 10, post 107, flattened-top post 110, and L post 102. Although flattened-top post 110 is at the left-hand side of post 107 in FIG. 10c, there is a different type of metal base for which flattened-top post and regular post switch their positions.

Since a window cap will be welded directly to the top surface of bottom flange 104 and there is no mesa to confine the position of the window cap. Therefore, the alignment of a window cap to metal base 101 and the like, thus to the laser chip, will be very difficult to control. For accurate alignment of a window cap to this kind of metal base, active alignment method is employed, which is expensive and throughput is low.

Top surface 106 is approximately parallel to the top surface of bottom flange 104, but not approximately parallel to top surface 103. This feature makes wire bonding difficult without rotating the metal base during wire bonding process.

Metal base 101 is typically used for edge emitting laser diode (LD) packages and the like.

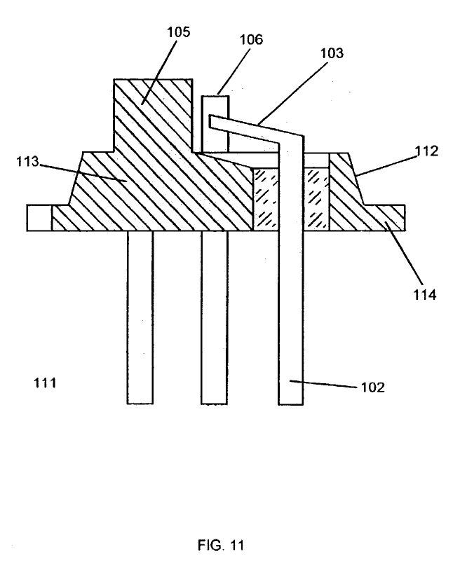

FIG. 11 is a sectional view of tapered metal base 111, comprising mesa 113, tapered side surface 112 of mesa 113, bottom flange 114, pedestal 105, and L post 102. Mesa 113 sits on bottom flange 114. Pedestal 105 sits on mesa 113.

Tapered side surface 112 will align with a tapered window cap with high accuracy when welding the tapered window cap to bottom flange 114 of metal base 111.

Metal base 111 adds a new structure, mesa 113 with tapered side surface 112, to metal base 101 of prior art.

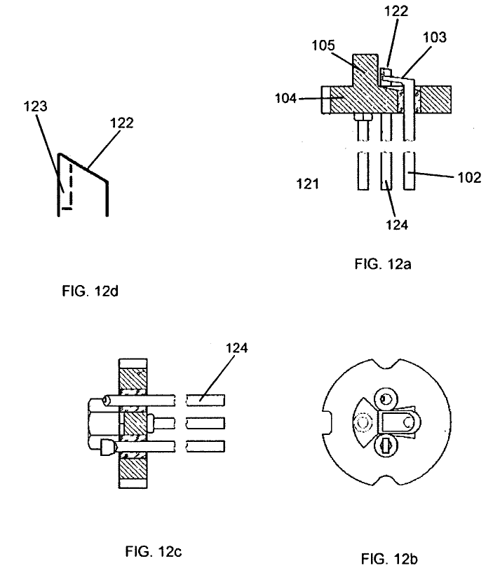

FIG. 12a is a sectional view of metal base 121, comprising bottom flange 104, tilted-top post 124, tilted-top surface 122 of tilted-top post 124, and L post 102. Pedestal 105 sits on bottom flange 104. Tilted-top surface 122 of tilted-top post 124 is made in a way such that tilted-top surface 122 is approximately parallel to top surface 103 of L post 102. This feature allows a wire to be reliably bonded to the two approximately parallel surfaces without rotating metal base during wire bonding process.

FIG. 12b is a top view of metal base 121.

FIG. 12c is a sectional view of metal base 121, comprising tilted-top post 124.

FIG. 12d is a detailed sectional view of the top portion of tilted-top post 124, comprising key 123 and top surface 122 of tilted-top post 124. Key 123 is on the top portion of tilted-top post 124 and is for properly orienting tilted-top post 124 in post-housing 125 such that tilted-top surface 122 is approximately parallel to top surface 103.

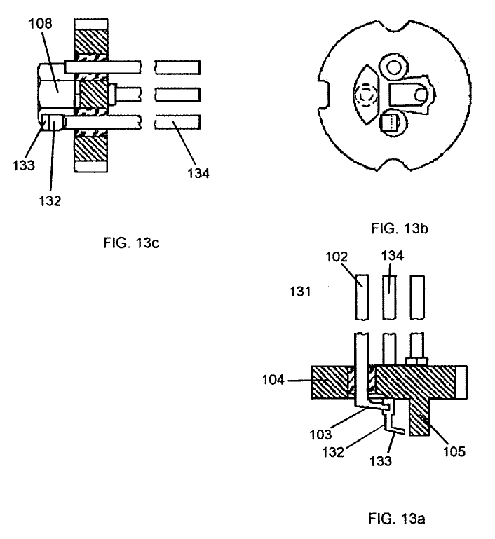

FIG. 13a is a sectional view of metal base 131. Metal base 131 comprises a novel feature, two-bonding-surface post 134 which has bent-bonding-surface 133 and vertical-bonding surface 132. Metal base 131 comprises also L post 102, top surface 103 of L post 102, bottom flange 104, and pedestal 105. Pedestal 105 sits on bottom flange 104.

FIG. 13b is a top view of metal base 131.

FIG. 13c is a sectional view of metal base 131.

Two-bonding-surface post 134 provides two surfaces for wire bonding, one is vertical-bonding surface 132 that is approximately parallel to vertical side surface 108, another one is bent-bonding-surface 133 that is approximately parallel to top surface 103. Bent-bonding-surface 133 is adjacent to vertical-bonding surface 132.

Metal base 131 replaces flattened-top-surface post 110 of metal base 101 with a new structure, two-bonding-surface post 134.

Therefore the wire bonding process, in which a wire is bonded to two approximately parallel surfaces, either bent-bonding surface 133 and top surface 103, or vertical-bonding surface 132 and vertical side surface 108, is reliable and there is no need to rotate the metal base after the wire is bonded to the first surface.

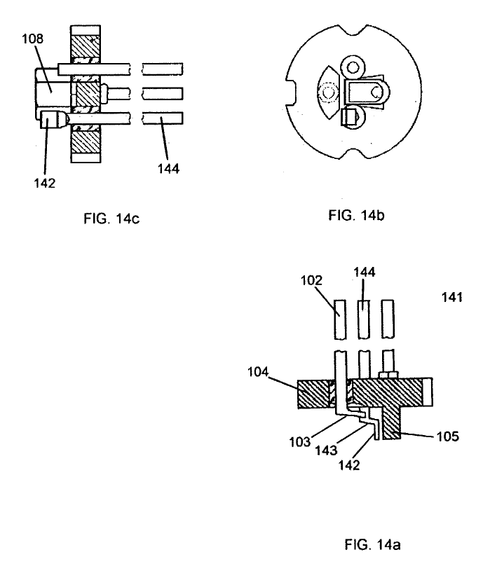

FIG. 14a is a sectional view of metal base 141, comprising two-bonding-surface post 144, bent-bonding-surface 143 of two-bonding-surface post 144, vertical-bonding surface 142 of two-bonding-surface post 144, L post 102, top surface 103 of L post 102, bottom flange 104, and pedestal 105. Pedestal 105 sits on bottom flange 104.

FIG. 14b is a top view of metal base 141.

FIG. 14c is a sectional view of metal base 141.

Two-bonding-surface post 144 provides two surfaces for wire bonding, one is vertical-bonding surface 142 that is approximately parallel to vertical side surface 108, another one is bent-bonding-surface 143 that is approximately parallel to top surface 103. Bent-bonding-surface 143 is adjacent to vertical-bonding surface 142.

Two-bonding-surface post 144 of metal base 141 shows a different configuration of two-bonding-surface post 134. The scope of two-bonding-surface post of the present invention should not be limited to those two configurations.

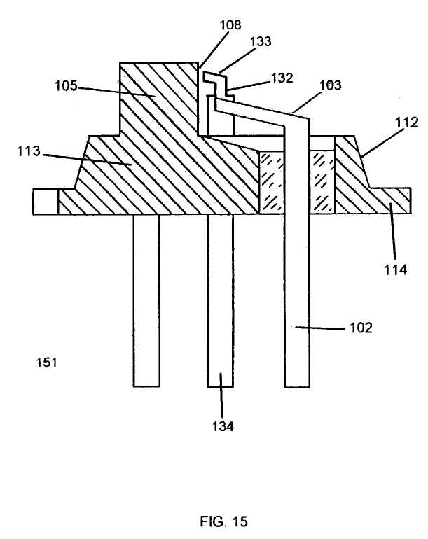

FIG. 15 is a sectional view of tapered metal base 151, comprising two-bonding-surface post 134, bent-bonding-surface 133, vertical-bonding surface 132, L post 102, top surface 103 of L post 102, bottom flange 114, mesa 113 with tapered side surface 112, and pedestal 105. Pedestal 105 sits on mesa 113. Mesa 113 sits on bottom flange 114.

Metal base 151 shows a combination of two new structures, a mesa with tapered side surface and a two-bonding-surface post

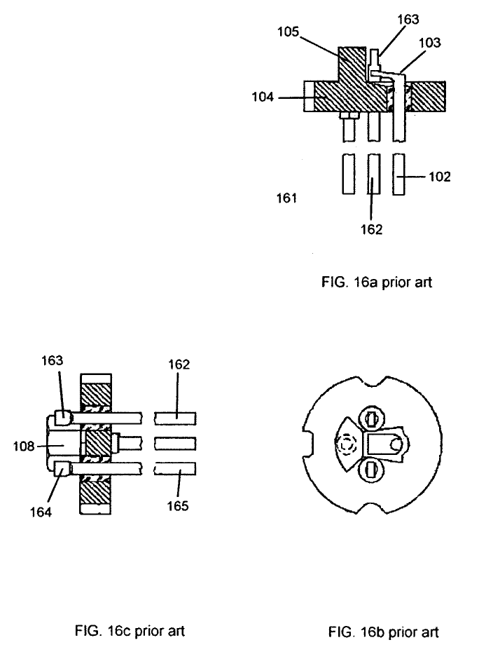

FIG. 16a is a sectional view of metal base 161 of prior art, typically called C type metal base, comprising flattened-top post 162, flattened-top surface 163 of flattened-top post 162, bottom flange 104, top surface 103 of L post 102, and pedestal 105 sits on bottom flange 104.

FIG. 16b is a top view of metal base 161.

FIG. 16c is a sectional view of metal base 161, comprising flattened-top surface 163, flattened-top post 162, flattened-top post 165, flattened top surface 164 of flattened-top post 165, and vertical side surface 108 of pedestal 105. Flattened-top surface 163, flattened-top surface 164, and vertical side surface 108 are approximately parallel to each other.

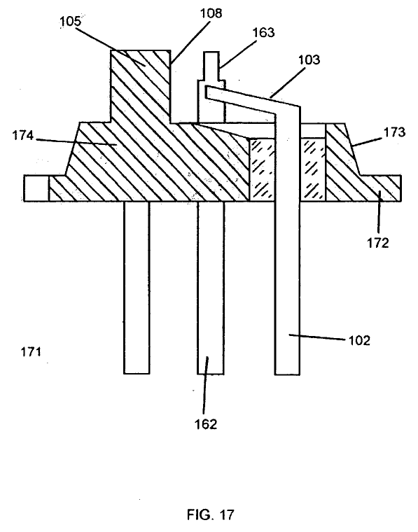

FIG. 17 is a sectional view of metal base 171, comprising mesa 174, tapered side surface 173 of mesa 174, bottom flange 172, pedestal 105 with vertical side surface 108, flattened-top post 162 with flattened-top surface 163, and L post 102 with top surface 103. Mesa 174 sits on bottom flange 172. Pedestal 105 sits on mesa 174.

Metal base 171 adds a new structure, mesa 174 with tapered side surface 173, to metal base 161 of prior art. Tapered side surface 173 aligns with a tapered window cap with high accuracy when welding the tapered window cap to bottom flange 172 of metal base 171.

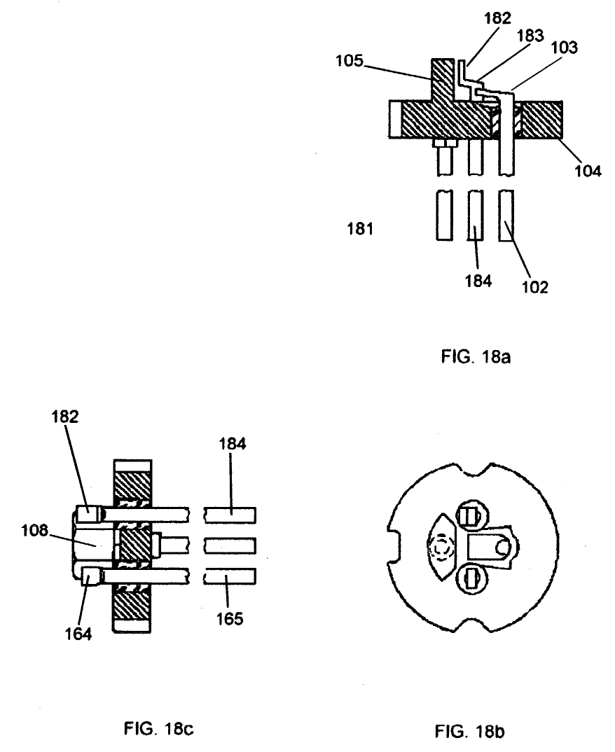

FIG. 18a is a sectional view of metal base 181, comprising two-bonding-surface post 184, bent-bonding-surface 183 of two-bonding-surface post 184, vertical-bonding surface 182 of two-bonding-surface post 184, L post 102, top surface 103 of L post 102, bottom flange 104, and pedestal 105. Pedestal 105 sits on bottom flange 104.

FIG. 18b is a top view of metal base 181.

FIG. 18c is a sectional view of metal base 181, comprising vertical side surface 108, vertical-bonding surface 182, and flattened top surface 164 of flattened-top post 165.

Two-bonding-surface post 184 provides two bonding surfaces for wire bonding, one is vertical-bonding surface 182 that is approximately parallel to vertical side surface 108, another one is bent-bonding-surface 183 that is approximately parallel to top surface 103. Bent-bonding-surface 183 is adjacent to vertical-bonding surface 182.

Metal base 181 replaces flattened-top post 164 with two-bonding-surface post 182, but not limited to replace flattened-top post 162. Metal base 181 may replaces flattened-top post 165 with a two-bonding-surface post.

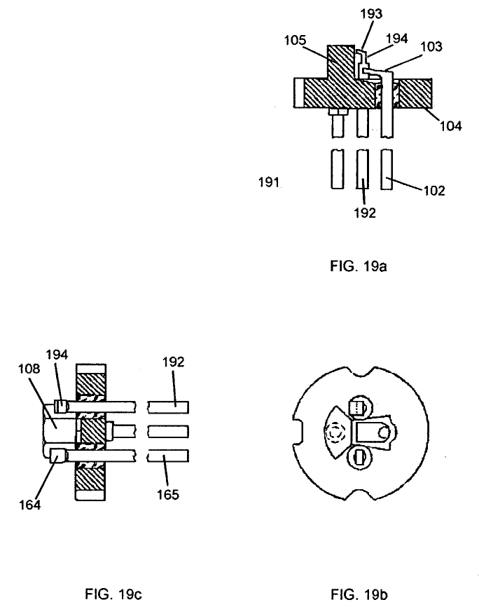

FIG. 19a is a sectional view of metal base 191, comprising two-bonding-surface post 192, bent-bonding-surface 193 of two-bonding-surface post 192, vertical-bonding surface 194 of two-bonding-surface post 192, L post 102, top surface 103 of L post 102, bottom flange 104, and pedestal 105. Pedestal 105 sits on bottom flange 104.

FIG. 19b is a top view of metal base 191.

FIG. 19c is a sectional view of metal base 191, comprising vertical side surface 108 and flattened top surface 164 of flattened-top post 165.

Two-bonding-surface post 192 provides two surfaces for wire bonding, one is vertical-bonding surface 194 that is approximately parallel to vertical side surface 108, another one is bent-bonding-surface 193 that is approximately parallel to top surface 103 of L post 102. Bent-bonding-surface 193 is adjacent to vertical-bonding surface 194.

Two-bonding-surface post 192 shows a different configuration of two-bonding-surface post 184. The scope of two-bonding-surface post of the present invention should not be limited to those two configurations.

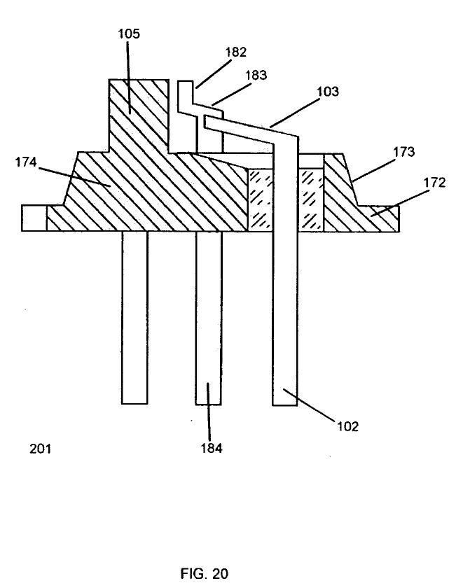

FIG. 20 is a sectional view of metal base 201, comprising two-bonding-surface post 184, bent-bonding-surface 183 of two-bonding-surface post 184, vertical-bonding surface 182 of two-bonding-surface post 184, L post 102, top surface 103 of L post 102, bottom flange 172, mesa 174 with tapered side surface 173, and pedestal 105. Pedestal 105 sits on mesa 174. Mesa 174 sits on bottom flange 172.

Metal base 201 shows a combination of two new structures, a mesa with tapered side surface and a two-bonding-surface post added to metal base 161 of prior art.

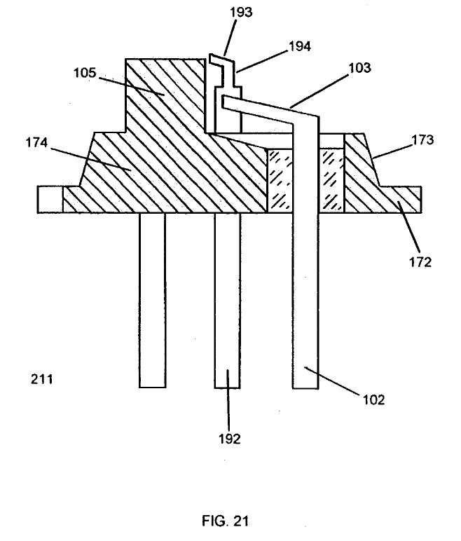

FIG. 21 is a sectional view of metal base 211, comprising two-bonding-surface post 192, bent-bonding-surface 193 of two-bonding-surface post 192, vertical-bonding surface 194 of two-bonding-surface post 192, L post 102, top surface 103 of L post 102, bottom flange 172, mesa 174 with tapered side surface 173, and pedestal 105. Pedestal 105 sits on mesa 174. Mesa 174 sits on bottom flange 172.

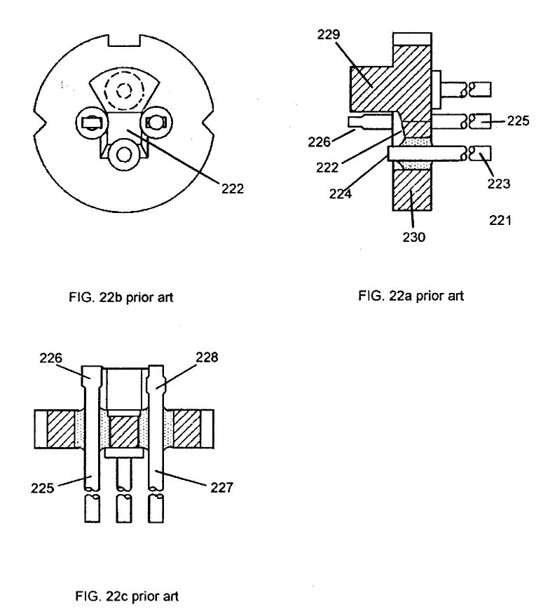

FIG. 22a is a sectional view of metal base 221 of prior art. Metal base 221 comprises bottom flange 230. Tilted area 222 is located at the center portion of bottom flange 230 and is at an angle with the top surface of bottom flange 230. There are post 223 with top surface 224 and flattened-top post 225 with flattened-top surface 226. Pedestal 229 sits on bottom flange 230. Tilted area is commonly for mounting monitoring chip.

FIG. 22b is a top view of metal base 221.

FIG. 22c is a sectional view of metal base 221 comprising flattened-top post 225 with flattened top surface 226 and flattened-top post 227 with flattened top surface 228.

Flattened-top surface 226 and flattened-top surface 228 are approximately parallel to each other.

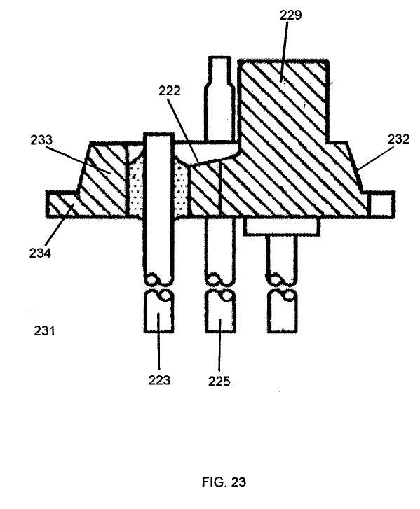

FIG. 23 is a sectional view of metal base 221, comprising post 223, flattened-top post 225, bottom flange 234, mesa 233 sitting on bottom flange 234, pedestal 229 sitting on mesa 233, tilted area 222, and tapered side surface 232 of mesa 233.

Metal base 231 adds a new structure, mesa 233 with tapered side surface 232, to metal base 221 of prior art.

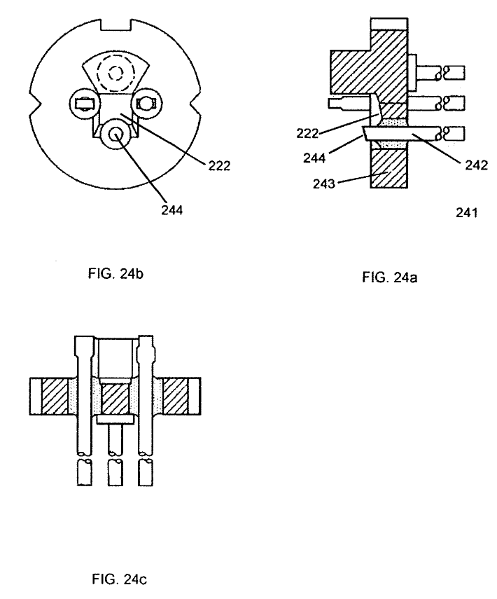

FIG. 24a is a sectional view of metal base 241. Metal base 241 comprising bottom flange 243, tilted area 222. Post 242 has tilted top surface 244 that is approximately parallel to the top surface of tilted area 222. This feature makes wire bonding robust without rotating metal base during wire bonding process.

FIG. 24b is a top view of metal base 241 showing tilted area 222 and tilted top surface 244 of post 242.

FIG. 24c is a sectional view of metal base 241.

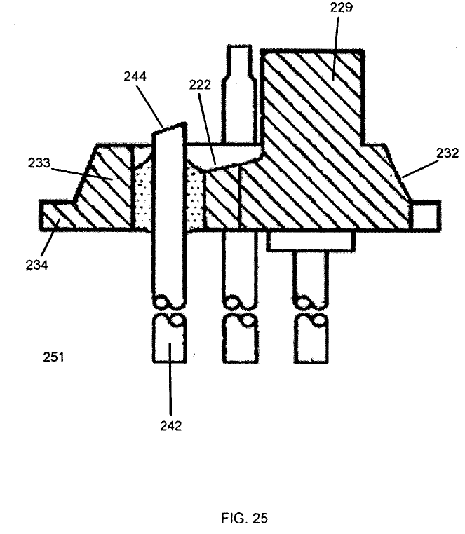

FIG. 25 is a sectional view of metal base 251, comprising mesa 233 sitting on bottom flange 234 and having tapered side surface 232, and tilted-top post 242 having tilted-top surface 244. Metal base 251 has a combination of two new features provided in FIG. 23 and FIG. 24.

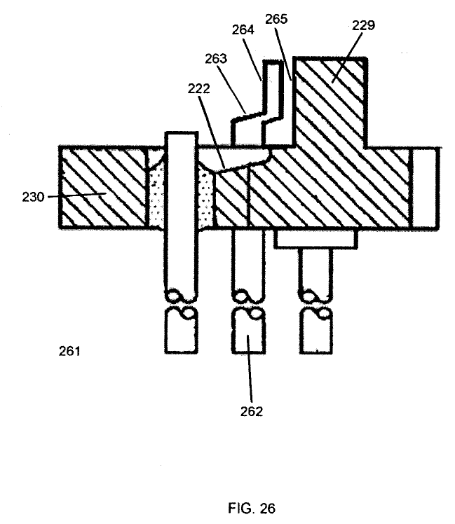

FIG. 26 is a sectional view of metal base 261, comprising bottom flange 230, and pedestal 229 having a vertical side surface 265. Two-bonding-surface post 262 has bent-bonding surface 263 and vertical-bonding surface 264 that is approximately parallel to vertical side surface 265. The feature that the top surface of tilted area 222 and bent-bonding surface 263 are approximately parallel to each other makes wire bonding robust without rotating metal base during wire bonding process.

Metal base 261 adds a new feature, two-bonding-surface post, to metal base 221 of prior art.

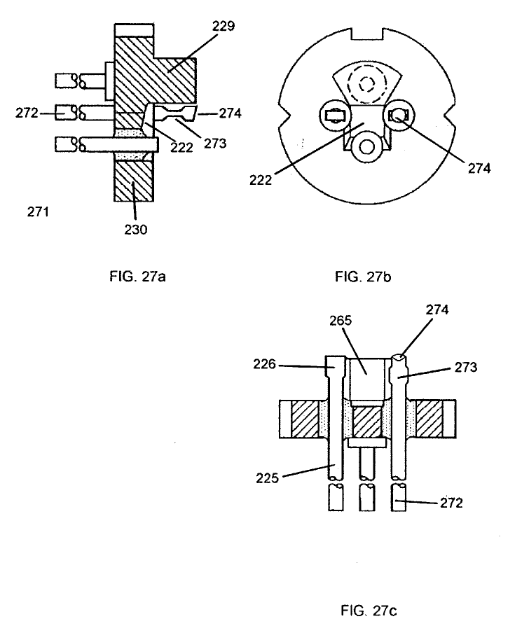

FIG. 27a is a sectional view of metal base 271. Pedestal 229 sits on bottom flange 230. Two-bonding-surface post 272 has vertical-bonding surface 273 that is approximately parallel to the vertical side surface of pedestal 229 and tilted-top surface 274 that is approximately parallel to the top surface of tilted area 222.

FIG. 27b is a top view of metal base 271 comprising tilted area 222 and tilted-top surface 274.

FIG. 27c is a sectional view of metal base 271. Flattened-top surface 226 of flattened-top post 225, vertical side surface 265 of pedestal 229, and vertical-bonding surface 273 are approximately parallel to each other.

Metal base 271 provides a two-bonding-surface post with different configuration to metal base 221 of prior art.

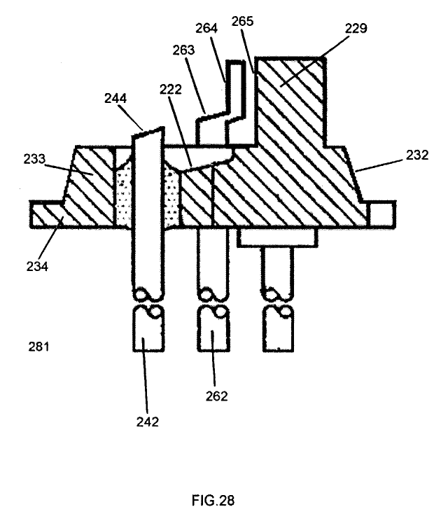

FIG. 28 is a sectional view of metal base 281. Pedestal 229 sits on mesa 233 that sits on bottom flange 234. Pedestal 229 has vertical side surface 265. Mesa 233 has tapered side surface 232. Two-bonding-surface post 262 has both vertical-bonding surface 264 that is approximately parallel to vertical side surface 265 and bent-bonding surface 263 that is approximately parallel to the top surface of tilted area 222. Tilted-top surface 244 of tilted top post 242 is approximately parallel to the top surface of tilted area 222.

Metal base 281 has three new structures, mesa 233 with tapered side surface 232, two-bonding-surface post 262, and tilted-top surface 244, added to metal base 221 of prior art.

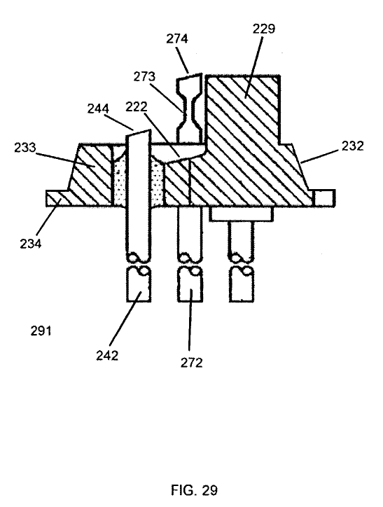

FIG. 29 is a sectional view of metal base 291. Pedestal 229 sits on mesa 233 that sits on bottom flange 234. Mesa 233 has tapered side surface 232. Two-bonding-surface post 272 has both vertical-bonding surface 273 that is approximately parallel to the vertical side surface of pedestal 229 and tilted-top surface 274 that is approximately parallel to the top surface of tilted area 222. Tilted-top surface 244 of tilted top post 242 is approximately parallel to the top surface of tilted area 222.

The novel feature, a post has two bonding surfaces, of the present invention is set forth in the claim. FIGS. 13, 14, 15, 18, 19, 20, 21, 26, 27, 28, and 29 are examples of a post having two bonding surfaces for wire bonding. The two bonding surfaces on the same post may have different shapes, forms, and positions.

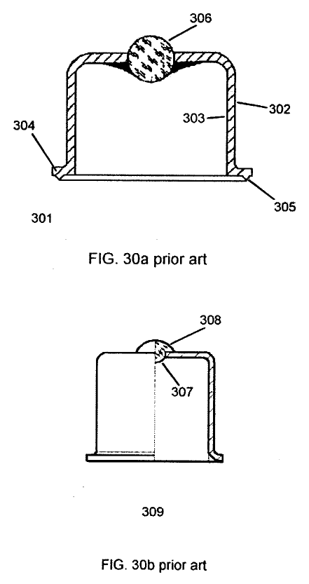

FIG. 30a is a sectional view of window cap 301 of prior art, comprising vertical inside surface 303, vertical outside surface 302, foot 304, ball lens 306, and projection 305. Hereafter call the portion near ball lens as the top portion, the portion near the foot as the bottom portion.

FIG. 30b is a sectional view of window cap 309 of prior art. The ball lens has large radius 308 for top half of the ball lens and small radius 307 for bottom half. All of new structures/features of the present invention for ball lens window cap apply to window cap 309. Ball lens window caps with perfectly spherical ball lens are employed for the drawings of the ball lens window caps of the present invention.

When welding window cap 301 of prior art to metal bases of prior art, projection 305 will sit on the top surface of the bottom flange and melt to weld foot 304 to the bottom flange. The alignment of window cap 301 to metal bases is dependent on the following factors:

(1) Alignment between top and bottom electrodes of welding equipment, which is not accurate enough for high-speed semiconductor laser diode package;

(2) The difference between the diameter of vertical outside surface 302 of window cap 301 and the inner diameter of the top electrode of welding equipment is too big for laser diode package;

(3) How accurate the bottom electrode of welding equipment can hold metal bases, which is loose for high-speed semiconductor laser diode package; and

(4) The different between the outer diameter of a mesa and the diameter of the vertical inside surface 303.

When welding window cap 301 of prior art to metal base 11 of prior art, the combination of the tolerance of the diameter of vertical inside surface 303 of window cap 301 and the tolerance of the outer diameter of mesa 18 of metal base 11 is so big that the alignment of the window cap to the metal base is not accurate enough for high-speed laser diode package. This is one of main reasons that there is no high-speed laser diode package with ball lens window caps.

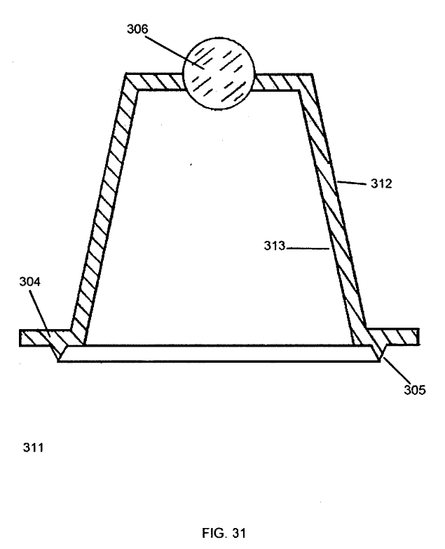

FIG. 31 is a sectional view of tapered window cap 311, comprising ball lens 306, foot 304, and projection 305 located under foot 304. Tapered inside surface 313 is from the top of window cap 311 to foot 304. Tapered outside surface 312 is from the top of window cap 311 to the top surface of foot 304. Projection may have variety of shapes.

The angle of tapered inside surface 312 matches the angle of the tapered side surface of the mesa of a metal base so that tapered window cap will self-align to the tapered metal base. Therefore the laser diode chip will automatically align to the tapered window cap, since the laser diode chip has been aligned to the metal base during pick-place process.

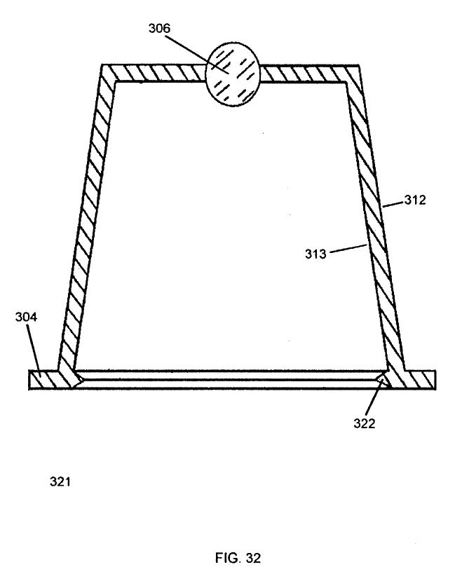

FIG. 32 is a sectional view of tapered window cap 321, comprising ball lens 306, foot 304, and tapered inside surface 313. Projection 322 is located on the bottom portion of tapered inside surface 313. The bottom portion of tapered inside surface 313 is near foot 304.

During the active alignment process, it may be required to tilt a window cap to optimize the output of laser light beam. Projection 322 working with the tapered side surface of the mesa of metal bases meets the requirement.

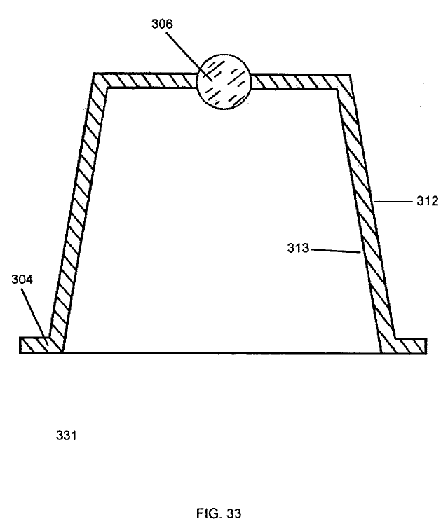

FIG. 33 is a sectional view of tapered window cap 331, comprising ball lens 306, foot 304, tapered outside surface 312, and tapered inside surface 313. There is no projection on window cap 331.

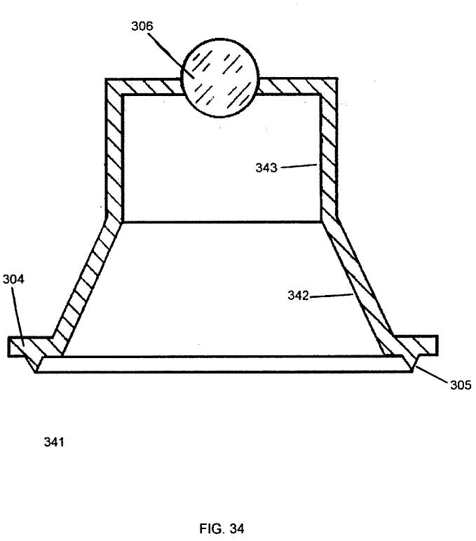

FIG. 34 is a sectional view of partially tapered window cap 341, comprising ball lens 306, foot 304, projection 305 located under foot 304. Tapered inside surface 342 is at the bottom portion of window cap 341. Vertical inside surface 343 is adjacent/above tapered inside surface 342.

The dimensions of tapered inside surface 342 and vertical inside surface 343 are not to scale.

The angle of tapered inside surface 342 matches the angle of the tapered side surface of the mesa of a metal base so that tapered window cap will self align to the tapered metal base. Therefore the laser diode chip will automatically align to the tapered window cap.

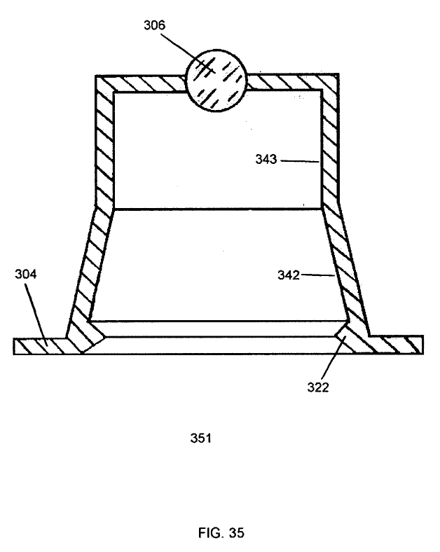

FIG. 35 is a sectional view of partially tapered window cap 351, comprising ball lens 306, foot 304, tapered inside surface 342. Vertical inside surface 343 is adjacent/above tapered inside surface 342. Projection 322 is located on the bottom portion of tapered inside surface 342. Projection 322 is no limited to the shape in FIG. 35.

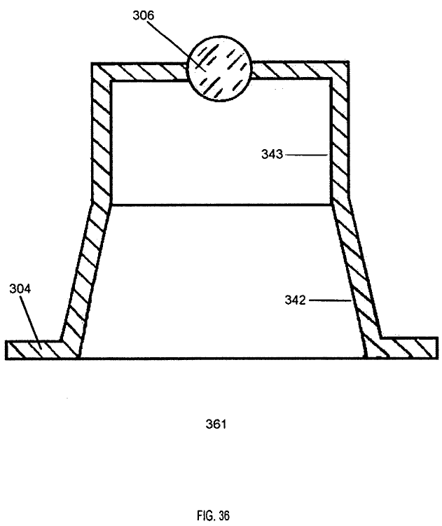

FIG. 36 is a sectional view of partially tapered window cap 361, comprising ball lens 306, foot 304, and tapered inside surface 342. Vertical inside surface 343 is adjacent/above tapered inside surface 342. There is no projection for window cap 361.

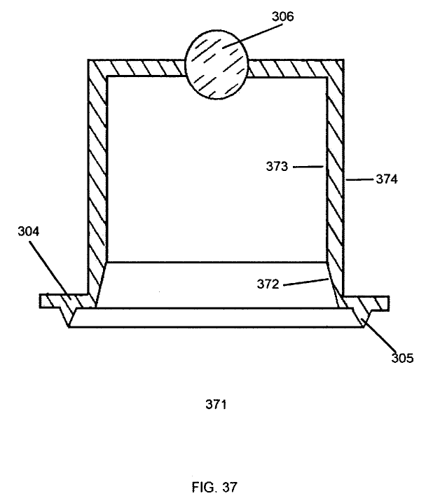

FIG. 37 is a sectional view of tapered window cap 371, comprising ball lens 306, and foot 304. Tapered inside surface 372 is located at the bottom portion of tapered window cap 371. Vertical inside surface 373 is adjacent/above tapered inside surface 372. Vertical outside surface 374 is from the top of window cap to foot 304. Projection 305 is located under foot 304.

Vertical outside surface 374 is easy to interface with other fiber optical devices/connectors.

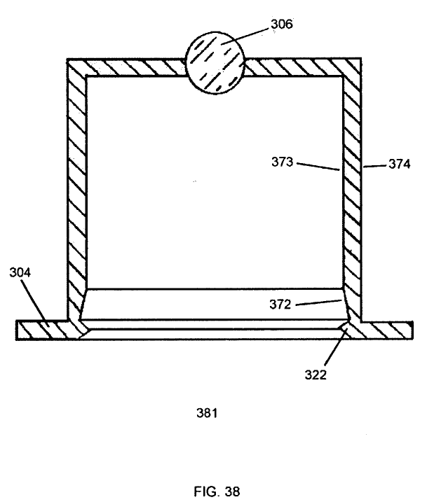

FIG. 38 is a sectional view of tapered window cap 381, comprising ball lens 306, and foot 304. Tapered inside surface 372 is located at the bottom portion of tapered window cap 381. Vertical inside surface 373 is adjacent/above tapered inside surface 372. Vertical outside surface 374 is from the top of tapered window cap 381 to foot 304. Projection 322 is located at the bottom portion of tapered inside surface 372.

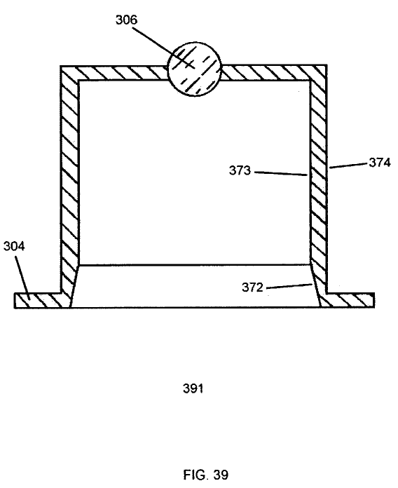

FIG. 39 is a sectional view of tapered window cap 391, comprising ball lens 306, and foot 304. Tapered inside surface 372 is located at the bottom portion of window cap 391. Vertical inside surface 373 is adjacent/above tapered inside surface 372. Vertical outside surface 374 is from the top of window cap 391 to foot 304. There is no projection.

The angle of tapered inside surface 372 of tapered window cap 371, 381, and 391 matches the angle of the tapered side surface of the mesa of a tapered metal base so that tapered window cap will self align to the tapered metal base. Therefore the laser diode chip will automatically align to tapered window cap.

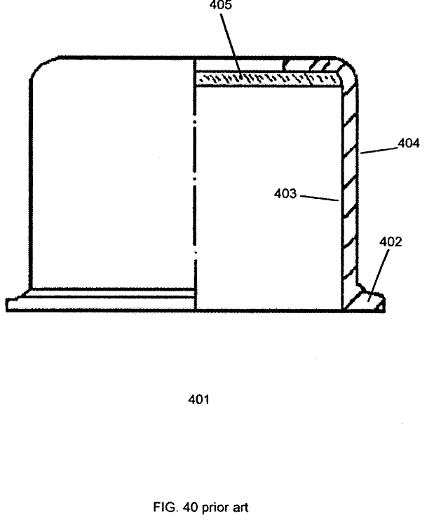

FIG. 40 is a partially sectional view of flat window cap 401 of prior art, comprising vertical inside surface 403, vertical outside surface 404, foot 402, and flat window 405.

The alignment of a flat window cap to a metal base is not as critical as a ball lens cap. However, when connecting an optical fiber to a flat window package, the alignment of the flat window cap to the metal base is still important. Because the optical fiber will be aligned to the window cap and the laser chip has been aligned to the metal base, the window cap needs to be aligned with the metal base. Otherwise the optical fiber will have problem to couple the laser light.

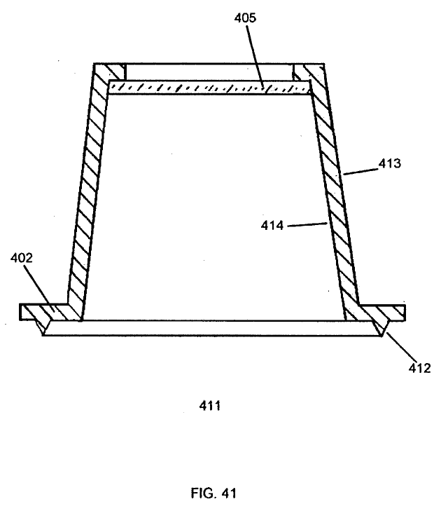

FIG. 41 is a sectional view of tapered window cap 411. Tapered window cap 411 has flat window 405 and foot 402. Tapered inside surface 414 is tapered from the top of tapered window cap 411 to foot 402. Projection 412 is under foot 402.

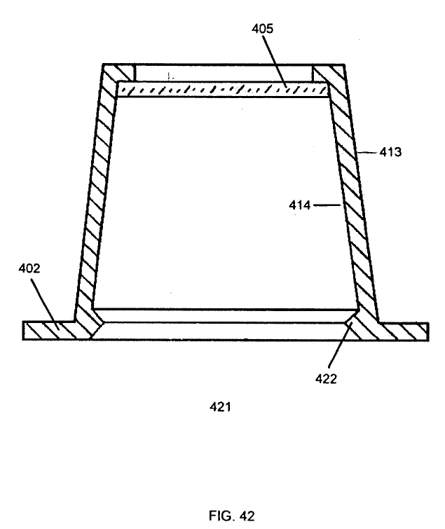

FIG. 42 is a sectional view of tapered window cap 421. Tapered window cap 421 has flat window 405 and foot 402. Tapered inside surface 414 and tapered outside surface 413 are tapered from the top of tapered window cap 421 to foot 402. Projection 422 is located on the bottom portion of tapered inside surface 414, which is near foot 402.

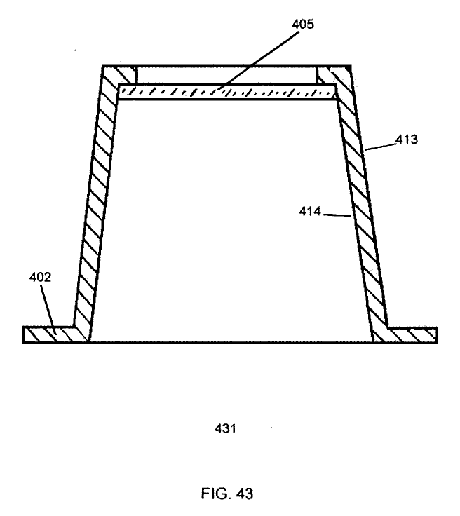

FIG. 43 is a sectional view of tapered window cap 431, comprising tapered inside surface 414, flat window 405, foot 402. There is no projection.

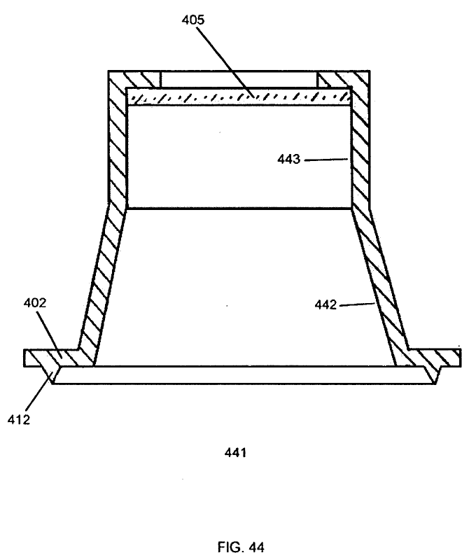

FIG. 44 is a sectional view of partially tapered window cap 441. Partially tapered window cap 441 comprises flat window 405, foot 402 and projection 412 located under foot 402. Vertical inside surface 443 is adjacent/above to tapered inside surface 442. The dimensions of tapered inside surface 442 and vertical inside surface 443 are not to scale.

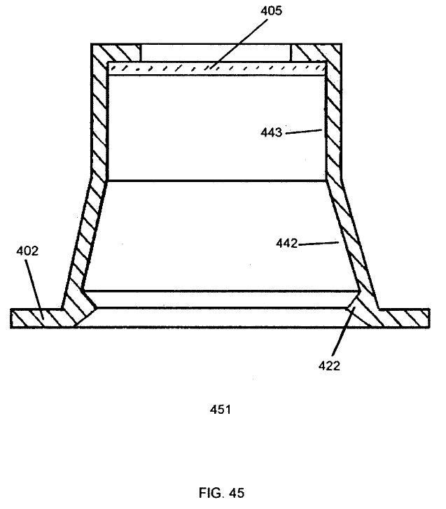

FIG. 45 is a sectional view of partially tapered window cap 451. Tapered inside surface 442 is adjacent/below to vertical inside surface 443. Partially tapered window cap 451 comprises flat window 405 and foot 402. Projection 422 is located on the bottom portion of tapered inside surface 442, which is near foot 402.

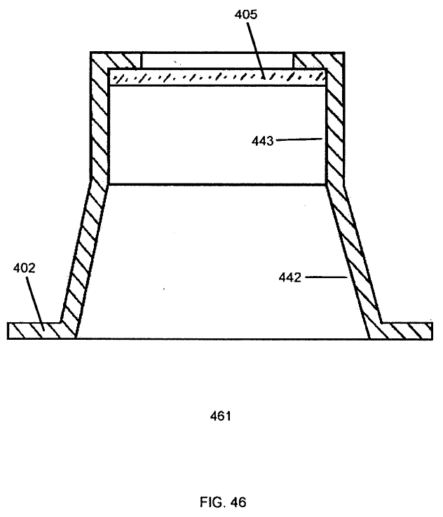

FIG. 46 is a sectional view of partially tapered window cap 461. Tapered inside surface 442 is adjacent to vertical inside surface 443 that is above tapered inside surface 442. Partially tapered window cap 461 comprises flat window 405 and foot 402. There is no projection.

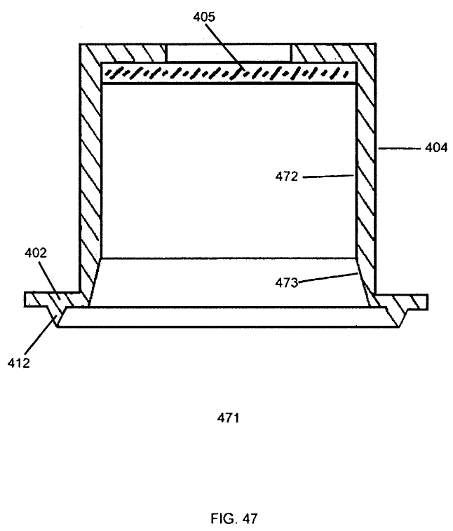

FIG. 47 is a sectional view of tapered window cap 471. Tapered window cap 471 comprises flat window 405 and foot 402. Tapered inside surface 473 is partial of entire inside surface. Vertical inside surface 472 is adjacent and above tapered inside surface 473. Vertical outside surface 404 is from the top that is near flat window 405 to foot 402. Projection 412 is located under foot 402.

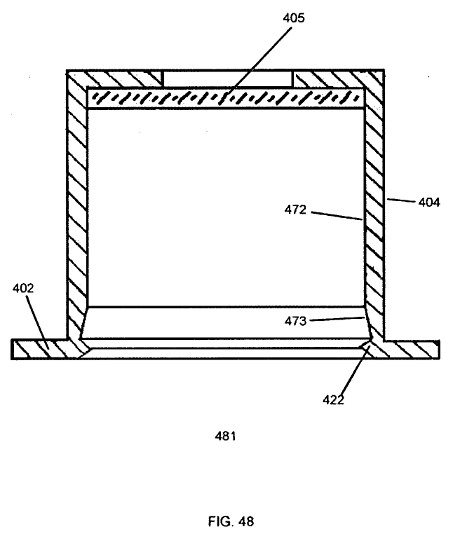

FIG. 48 is a sectional view of tapered window cap 481. Tapered window cap 481 comprises flat window 405 and foot 402. Vertical inside surface 472 is adjacent and above tapered inside surface 473. Vertical outside surface 404 is from the top that is near flat window 405 to foot 402. Projection 422 is located on the bottom portion of tapered inside surface 473.

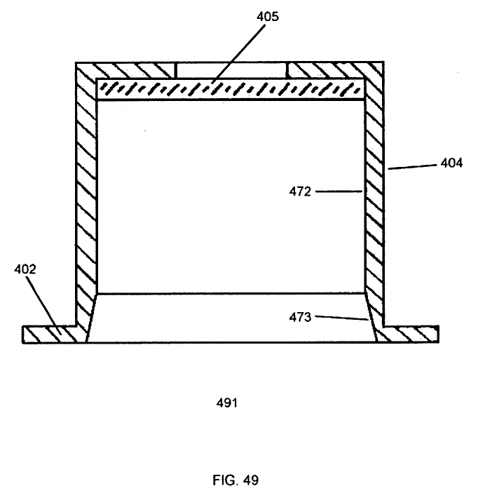

FIG. 49 is a sectional view of tapered window cap 491. Tapered window cap 491 comprises flat window 405 and foot 402. Tapered inside surface 473 is partial of entire inside surface. Vertical inside surface 472 is adjacent and above tapered inside surface 473. Vertical outside surface 404 is from the top that is near flat window 405 to foot 402. There is no projection for window cap 491.

The angle of tapered inside surface 473 of tapered window cap 471, 481, and 491 match the angle of the tapered side surface of the mesa of tapered metal bases of the present invention so that tapered window cap will self-align to the tapered metal bases. Therefore the laser diode chip will automatically align to tapered window cap.

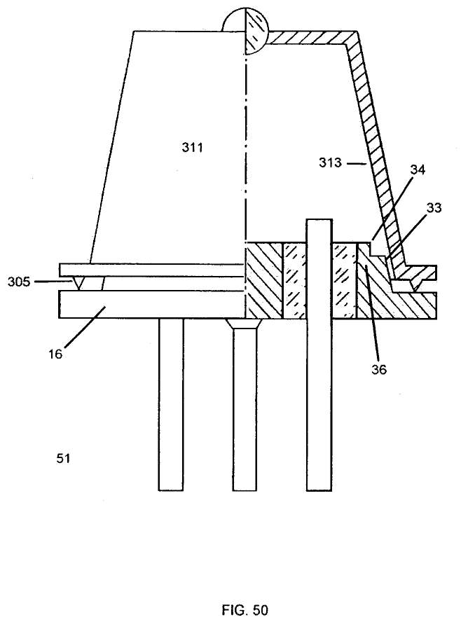

FIG. 50 is a partially sectional view of an assembly of tapered metal base 51 and tapered window cap 311.

Non-chamfered edge 34 and fiducial mark 53 (shown in FIG. 5b) allow PR system of automatic equipment to accurately find the center of metal base 51 and place laser diode chip accordingly.

Tapered side surface 33 of tapered metal base 51 and tapered inside surface 313 of tapered window cap 311 match to each other and, thus, allow window cap 311 to self-align to tapered metal base 51. Therefore laser diode is accurately aligned to window cap by a passive way.

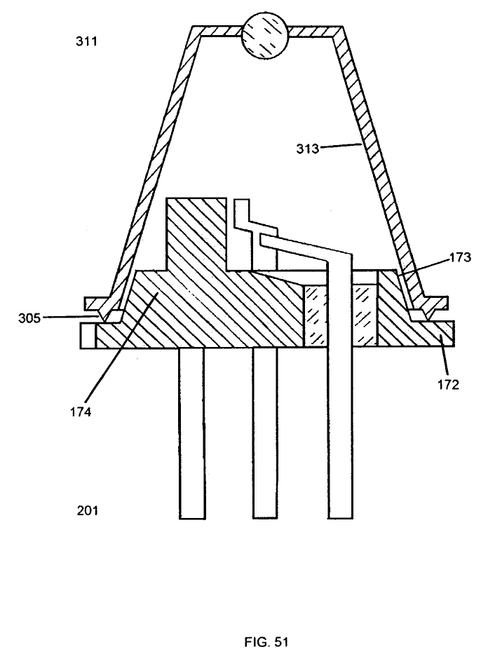

FIG. 51 is a sectional view of an assembly of tapered metal base 201 and tapered window cap 311.

Tapered side surface 173 of tapered metal base 201 matches tapered inside surface 313 of tapered window cap 311, so that tapered window cap 311 is self aligned to tapered metal base 201.

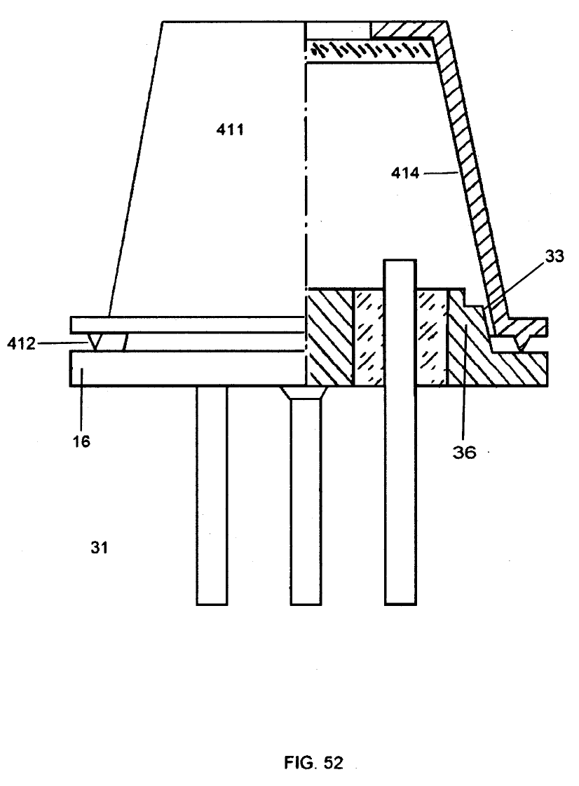

FIG. 52 is a sectional view of an assembly of tapered metal base 31 and tapered window cap 411.

Tapered side surface 33 of tapered metal base 31 and tapered inside surface 414 of tapered window cap 411 match to each other and, thus, allow tapered window cap 411 to self-align to tapered metal base 31. Therefore laser diode is accurately aligned to window cap by a passive way.

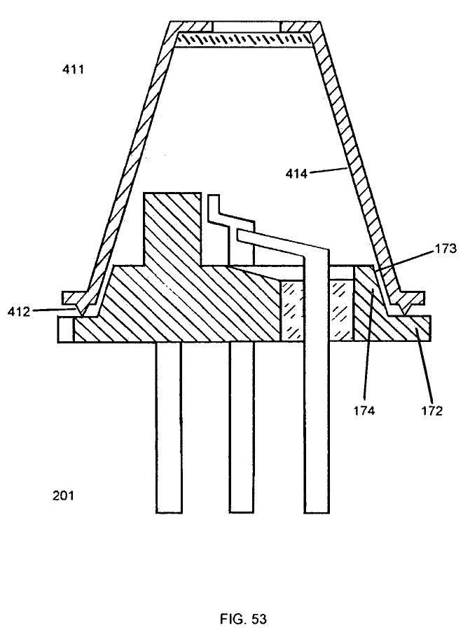

FIG. 53 is a sectional view of an assembly of tapered metal base 201 and tapered window cap 411.

Tapered side surface 173 of tapered metal base 201 and tapered inside surface 414 of tapered window cap 411 match to each other and, thus, allow tapered window cap 411 to self-align to tapered metal base 201. Therefore laser diode is accurately aligned to window cap by a passive way.

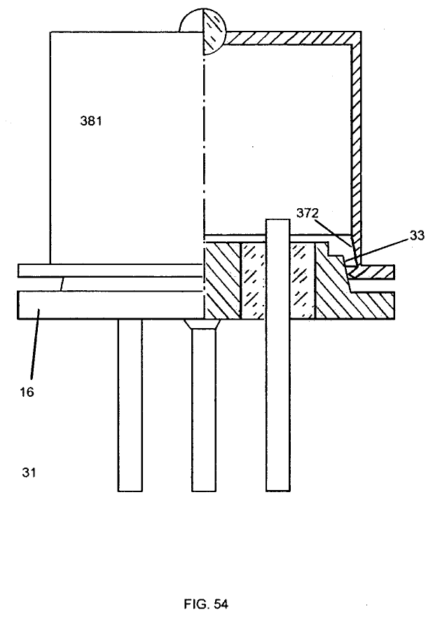

FIG. 54 is a sectional view of an assembly of tapered metal base 31 and tapered window cap 381.

Tapered side surface 33 of tapered metal base 31 and tapered inside surface 372 of tapered window cap 381 match to each other and, thus, allow tapered window cap 381 to self-align to tapered metal base 31. Therefore laser diode is accurately aligned to window cap by a passive way

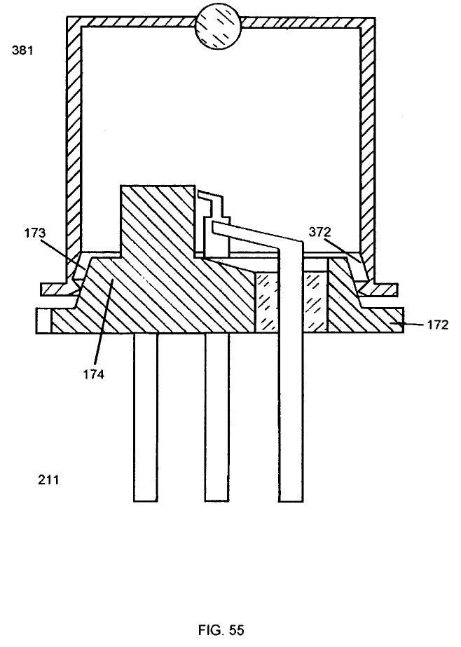

FIG. 55 is a sectional view of an assembly of tapered metal base 211 and tapered window cap 381.

Tapered side surface 173 of tapered metal base 211 and tapered inside surface 372 of tapered window cap 381 match to each other and, thus, allow tapered window cap 381 to self-align to tapered metal base 211. Therefore laser diode is accurately aligned to window cap by a passive way.

Further more, the active alignment procedure of connecting an optical fiber to the laser diode packages of the present invention, for examples as shown in FIGS. 50-55, will be fast and have high yield, i.e., increasing throughput. Also metal bases and window caps of this invention allow people to build high-speed semiconductor laser packages with high yield without using expensive equipment.

FIG. 50 to FIG. 55 are six examples of preferred embodiments of semiconductor laser diode package using different combinations of metal bases and window caps of the present invention. Semiconductor laser diode packages of other combinations of metal bases and window caps of the present invention are legal equivalents of the present invention.

By controlling how far a tapered window cap is pushed toward to a tapered metal base of the present invention during welding process, the distance between the ball lens and the metal base is accurately controlled.

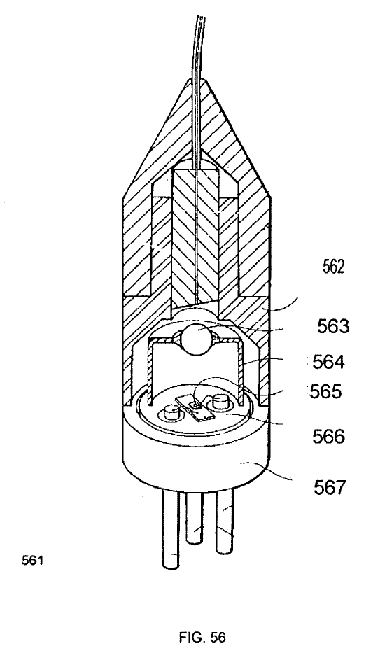

FIG. 56 is a partially sectional view of an assembly 561 of semiconductor laser diode package with a pigtail of prior art, comprising pigtail 562, ball lens 563, window cap 564, laser diode chip 565, top surface 566, and metal base 567.

Although the description above contains many specifications, these should not be construed as limiting the scope of the present invention but as merely providing illustrations of some of the presently preferred embodiments of the present invention.

Therefore the scope of the present invention should be determined by the claims and their legal equivalents, rather than by the examples given.

What we claim:

1. A new type of metal bases for semiconductor laser diode package comprising
a) a bottom flange,
b) a mesa sitting on said bottom flange and having a tapered side surface and a top surface,
c) a number of posts, and
d) a number of post housings.

2. The new type of metal bases of claim 1 further comprising a step surrounding said top surface of said mesa, having a vertical side surface, having an edge intersecting said top surface of said mesa and said vertical side surface of said step, and located between said top surface and said tapered side surface of said mesa.

3. A new type of metal bases for semiconductor laser diode package comprising
a) a bottom flange,
b) a mesa sitting on said bottom flange,
c) a number of posts,
d) a number of post housings, and
e) at least two fiducial marks located on a diagonal position on the top surface of said mesa.

4. The new type of metal bases of claim 3 wherein said mesa having a tapered side surface.

5. The new type of metal bases of claim 4 further comprising a step surrounding the top surface of said mesa, having a vertical side surface, having an edge intersecting the top surface of said mesa and said vertical side surface of said step, and located between the top surface of said mesa and said tapered side surface of said mesa.

6. A new type of metal bases for semiconductor laser diode package comprising
a) a bottom flange,
b) a pedestal sitting on the top of said bottom flange and having a vertical side surface for mounting laser diode chip,
c) a number of posts,
d) a number of post housings, and
e) a two-bonding-surface post having two bonding surfaces and one of said two bonding surfaces approximately parallels to said vertical side surface of said pedestal.

7. The new type of metal bases of claim 6 wherein one of said posts is a L post having a top surface that is at an angle with the top surface of said bottom flange, and one of said two bonding surfaces of said two-bonding-surface post approximately parallels to the top surface of said L post.

8. The new type of metal bases of claim 6 further comprising a tilted area that is at an angle with the top surface of said bottom flange and located at the center portion of said bottom flange, and one of said two bonding surfaces of said two-bonding-surface post approximately parallels to the top surface of said tilted area.

9. A new type of metal bases for semiconductor laser diode package comprising
a) a bottom flange,
b) a number of posts,
c) a number of post housings,
d) a mesa sitting on the top of said bottom flange and having a tapered side surface, and
e) a pedestal sitting on the top of said mesa and having a vertical side surface for mounting laser diode chip.

10. The new type of metal bases of claim 9 wherein one of said posts is a two-bonding-surface post having two bonding surfaces and one of said two bonding surfaces approximately parallels to said vertical side surface of said pedestal.

11. The new type of metal bases of claim 10 wherein one of said posts is a L post having a top surface that is at an angle with the top surface of said mesa, and one of said two bonding surfaces of said two-bonding-surface post approximately parallels to the top surface of said L post.

12. The new type of metal bases of claim 10 further comprising a tilted area that is at an angle with the top surface of said mesa and located at the center portion of said mesa, and one of said two bonding surfaces of said two-bonding-surface post approximately parallels to the top surface of said tilted area.

13. A new type of window caps for semiconductor laser diode package comprising:
a) a tapered inside surface,
b) a window, and
c) a foot.

14. The new type of window caps of claim 13 wherein said window is a ball lens window.

15. The new type of window caps of claim 13 wherein said window is a flat window.

16. The new type of window caps of claim 13 further comprising a projection located under said foot.

17. The new type of window caps of claim 13 further comprising a projection located on the bottom portion near said foot of said tapered inside surface.

18. The new type of window caps of claim 13 wherein said tapered inside surface is on the bottom portion near said foot of the inside surface and a vertical inside surface is adjacent to and above said tapered inside surface.

19. The new type of window caps of claim 18 further comprising
a projection located on the bottom portion of said tapered inside surface.

20. The new type of window cap of claim 18 further comprising a projection located under said foot.
Whereby the alignment process between a semiconductor laser diode chip, a metal base, and a window cap is substantially improved. Wire bonding process of semiconductor edge emitting laser diode package is substantially improved.
